(19) United States
(12) Patent Application Publication
(10) Pub. No.: US 2005/0285885 A1
(43) Pub. Date: Dec. 29, 2005

(54) Organic electroluminescent printer

(75) Inventor: Koji Terumoto, Kyoto (JP)

Correspondence Address: HAMRE, SCHUMANN, MUELLER & LARSON, P.C., P.O. BOX 2902-0902, MINNEAPOLIS, MN, 55402, US

(73) Assignee: ROHM CO., LTD., Kyoto-shi (JP)

(21) Appl. No.: 11/159,841

(22) Filed: Jun. 23, 2005

(30) Foreign Application Priority Data
Jun. 24, 2004 (JP) 2004-186215

(51) Int. Cl. B41J 29/38

(52) U.S. Cl. 347/5

(57) ABSTRACT

An organic EL printer includes an EL panel provided with red, green and blue light-emitting portions arranged in the form of a matrix to illuminate a photosensitive recording medium that is moved relative to the panel in the secondary scanning direction by one pitch distance in one pitch feed time. The printer also includes a drive controller for setting voltage application times, within the one pitch feed time, with respect to the red light-emitting portion, the green light-emitting portion and the blue light-emitting portion. The controller causes these light-emitting portions to emit light in accordance with the voltage application times. The one pitch feed time includes a non-luminescent time in addition to the voltage application times.

### BACKGROUND OF THE INVENTION

1. Field of the Invention

The present invention relates to an organic electroluminescent (EL) printer that comprises an organic EL panel utilizing organic EL elements.

2. Description of the Related Art

Organic electroluminescent elements, having advantages such as low power consumption and easiness of downsizing, are applied to many technical fields including computer displays, illuminators in printers, etc.

FIG. 5A of the accompanying drawings shows the basic structure of a conventional organic EL printer (see JP-A-2000-103114, for example). The illustrated printer B includes an organic EL panel B1 for illuminating a photosensitive recording medium B2. Specifically, the panel B1 includes a substrate 91 and three parallel arrays. (each extending in the primary scanning direction X) of light-emitting portions 94R, 94G and 94B that emit red (R) light, green (G) light and blue (B) light, respectively. These light-emitting portions are provided at the intersections of three scanning electrodes (cathodes, each elongated in the primary scanning direction X) 95 and a great number of signal electrodes (anodes, each elongated in the secondary scanning direction Y) 92 formed on the substrate 91.

The light-emitting portions 94R, 94G, 94B are activated (turned on) for light emission by the so-called “passive matrix driving method.” Specifically, “scanning voltage” is applied sequentially to the respective scanning electrodes 95 (first to the top electrode for red light, second to the middle electrode for green light, and third to the bottom electrode for blue light), while “signal voltage” is applied to the signal electrodes 92 (precisely, to selected ones among the signal electrodes 92). As a result, each organic portion located between a voltage-applied scanning electrode 95 and a voltage-applied signal electrode 92 emits light for illuminating the photosensitive recording medium B2. In the printing process, the recording medium B2 is moved in the secondary scanning direction Y relative to the EL panel B1, so that red, green and blue light beams strike upon the recording medium B2 for making latent dots of the required colors. Repeating this irradiation of light, with the recoding medium B2 being fed in the direction Y, produces the desired image (latent image) on the recoding medium B2.

In the conventional printer described above, the dots of the respective colors are to be equally spaced from each other in the direction Y. In conformity with this, as shown in FIG. 5B, a predetermined “one pitch feed time” TP (a time for which the recoding medium is moved by the predetermined 1 pitch P in the direction Y) is equally divided into three (TP/3), each allotted as a time for applying voltage to the relevant one of the light-emitting portions 94R, 94G, 94B for light emission.

With this conventional arrangement, however, as shown in FIG. 5C, each light-emitting portion is moved relative to the recording medium by a distance P/3 (P stands for 1 pitch) in the direction Y, with the light kept on for the voltage application time TP/3. Note that the double-dot chain lines (FIG. 5C(a)) represent the position of the light-emitting portion undergoing the one pitch displacement. Due to the movement by the distance P/3 (see (b)), the latent dot formed on the recoding medium is unduly elongated (see (c)) by the relative displacement Pb (=P/3). In addition, the amount of light exposure is different at places in the elongated dot. Specifically, the middle region of the dot is irradiated most brightly, while both ends of the dot are less irradiated (see the dot exposure distribution of (d)). With such a variation, the resultant image (developed image) may suffer density irregularity, and hence the deterioration of print quality. Further in the conventional printer, adjacent dots may overlap with each other due to the dot elongation in the direction Y. Such an overlap may become overly conspicuous in the developed image, thereby incurring deterioration in print quality.

### SUMMARY OF THE INVENTION

The present invention has been proposed under the circumstances described above. It is therefore an object of the present invention to provide an organic EL printer comprising an organic EL panel for illuminating a photosensitive recording medium moved relative to the panel, wherein the printer undergoes an advantageously less variation in amount of light exposure, thereby attaining an improvement in print quality.

According to the present invention, there is provided an organic EL printer comprising: an organic EL panel for illuminating a photosensitive recording medium, the panel including a plurality of light-emitting portions disposed in form of a matrix extending both in a primary scanning direction and in a secondary scanning direction, the plurality of light-emitting portions including a red light-emitting portion, a green light-emitting portion and a blue light-emitting portion; a moving unit for moving the recording medium and the panel relative to each other in the secondary scanning direction by one pitch distance in one pitch feed time; and a drive controller for setting voltage application times within the one pitch feed time with respect to the red light-emitting portion, the green light-emitting portion and the blue light-emitting portion, the drive controller causing the red light-emitting portion, the green light-emitting portion and the blue light-emitting portion to emit light in accordance with the voltage application times. The one pitch feed time includes a non-luminescent time in addition to the voltage application times.

In accordance with the present invention, the one pitch feed time includes a non-luminescent time, during which none of the red, green and blue light-emitting portions is activated for light emission. Accordingly, the voltage application times for the respective light-emitting portions can be shorter than the conventional one pitch feed time/3. Thus, the distance moved of each activated light-emitting portion is much shorter than the conventional distance, thereby reducing the elongation of a dot formed on the recording medium. Accordingly, the light exposure over the dot is uniformed, and the overlap of dots adjacent in the direction Y does not occur. Consequently, the print quality improves.

Preferably, each of the red light-emitting portion, the green light-emitting portion and the blue light-emitting portion may have a light-emitting efficiency, where these efficiencies are different from each other. In this connection, preferably, the voltage application times of the red light-emitting portion, the green light-emitting portion and the blue light-emitting portion may have lengths different from each other.

Preferably, the voltage application time of the red light-emitting portion may be longer than the voltage application time of the blue light-emitting portion, and wherein the voltage application time of the green light-emitting portion may be shorter than the voltage application time of the blue light-emitting portion.

With such an arrangement, the light exposure by the three kinds (R, G, B) of light-emitting portions can be uniformed by allotting the longest voltage application time to the light-emitting portion of the lowest light-emitting efficiency, an intermediate voltage application time to the light-emitting portion of an intermediate light-emitting efficiency, and the shortest voltage application time to the light-emitting portion of the highest light-emitting efficiency. Accordingly, in the developed image, the densities for the respective colors (R, G, B) are uniformed, thereby improving the print quality.

Preferably, the voltage application times of the red light-emitting portion, the green light-emitting portion and the blue light-emitting portion may be set continuously with each other. In this case, the non-luminescent time contained in the one pitch feed time is not divided into fragments, but remains as a single continuous period. Accordingly, the voltage application time for each light-emitting portion can be elongated within the wide range of the continuous period of time.

Other features and advantages of the present invention will become apparent from the detailed description given below with reference to the accompanying drawings.

### BRIEF DESCRIPTION OF THE DRAWINGS

FIG. 1A is a plan view illustrating the basic structure of an organic EL printer according to the present invention;

FIG. 1B shows the waveforms of scanning voltages applied to the light-emitting portions of the printer of the present invention;

FIG. 2 is a sectional view taken along lines II-II in FIG. 1A;

FIG. 3 illustrates a printed dot and its relationship with the distribution of light exposure;

FIG. 4 shows other waveforms of scanning voltages applied to the light-emitting portions of the printer of the present invention;

FIG. 5A is a plan view illustrating the basic structure of a conventional organic EL printer;

FIG. 5B shows waveforms of scanning voltages applied to the light-emitting portions of the conventional printer; and

FIG. 5C illustrates a printed dot and its relationship with the distribution of light exposure in the conventional system.

### DETAILED DESCRIPTION OF THE PREFERRED EMBODIMENTS

Preferred embodiments of the present invention will be described below with reference to the accompanying drawings.

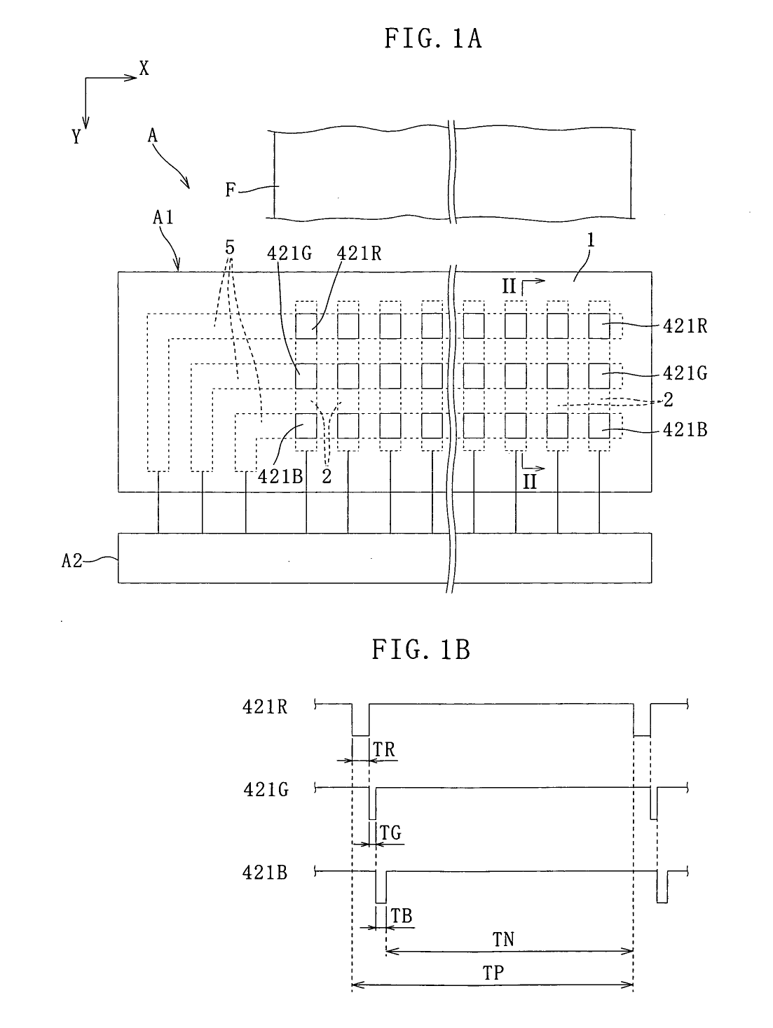

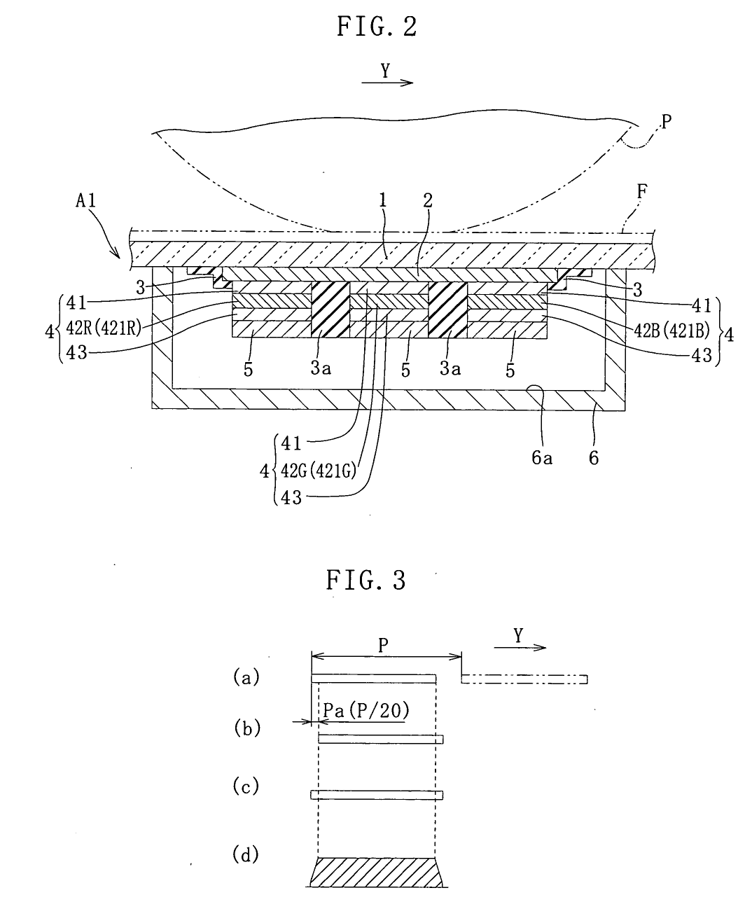

FIGS. 1A and 2 show an example of an organic EL printer according to the present invention. The illustrated printer A includes an organic EL panel A1 and a controller A2. The panel A1, used for illuminating a photosensitive recording medium F, includes a substrate 1, signal electrodes (anodes) 2, an insulating layer 3, organic layers 4, three scanning electrodes (cathodes) 5, and a sealing member 6.

The substrate 1 is a rectangular plate that is elongated in the primary scanning direction X and made of a transparent material (i.e., with high light transmittance), such as glass and plastic film. As shown in FIG. 2, the signal electrodes 2, the insulating layer 3, the organic layers 4 and the scanning electrodes 5 are stacked on the lower surface of the substrate 1.

As shown in FIG. 1A, the signal electrodes 2, each elongated in the secondary scanning direction Y, are parallel to each other and spaced from each other in the primary scanning direction X. The electrodes 2 are made of a transparent electroconductive material such as indium tin oxide (ITO). Specifically, the transparent electroconductive material is formed into a sufficiently large layer by vapor deposition or sputtering, for example. Then, the layer is subjected to etching for removing unnecessary portions to provide the desired form of the electrodes.

As seen from FIG. 2, the insulating layer 3 is formed partly on the substrate 1 and partly on the signal electrodes 2. The insulating layer 3 includes elongated raised portions or separators 3a (two separators, in the illustrated example) for electrically separating the adjacent organic layers 4 (and the scanning electrodes 5 formed thereon) from each other.

According to the present invention, the insulating layer 3 with the raised portions 3a may be formed before the organic layers 4 and the scanning electrodes 5 are formed. In this manner, the resultant organic layers 4 (three layers in the illustrated example) and/or scanning electrodes 5, which may be produced by vapor deposition, can be properly separated from the adjacent one due to the raised portions 3a. Alternately, the raised portions 3a may be disposed of when use is made of an appropriate mask capable of producing separate organic layers 4 and scanning electrodes 5.

Each of the organic layers 4, elongated in the primary scanning direction X, may be made up of three sub-layers: a hole transport layer 41, a luminescent layer 42, and an electron transport layer 43. The hole transport layer 41 and the electron transport layer 43 are the same for the three organic layers 4, while the luminescent layer 42 is different for the layers 4. Specifically, the luminescent layers 42 (42R, 42G, 42B) of the respective organic layers 4 are designed to emit red light (R), green light (G), and blue light (B). According to the present invention, the organic layer 4 may comprise more sub-layers (such as a hole injection layer and an electron injection layer) or only a single layer (the luminescent layer).

The three scanning electrodes 5 are formed on the luminescent layers 42R, 42G and 42B, respectively, each being elongated in the primary scanning direction X. The electrodes 5 may be made of a highly electroconductive material such as aluminum. Specifically, the material is formed into a thin film by vapor deposition or sputtering, and then unnecessary portions of the film are removed by photolithography, for example.

Each signal electrode 2 and each scanning electrode 5 are connected to the controller A2. In accordance with image data supplied externally, the controller A2 applies voltage to the signal electrodes 2 in synchronism with the clock pulse signal via drive ICs (not shown) incorporated in the controller A2. Meanwhile, the controller A2 applies voltage to the scanning electrodes 5 in a line-sequential manner. With such line-sequential passive matrix drive, selected light-emitting portions 421R, 421G, 421B (located at intersections of the signal electrodes 2 and the scanning electrodes 5) of the luminescent layers 42R, 42G, 42B are turned on (i.e., a hole and an electron are coupled) to emit light for illuminating the photosensitive recording medium F.

The sealing member 6 is formed with a space 6a that accommodates the signal electrodes 2, the insulating layer 3, the organic layers 4, and the scanning electrodes 5. The sealing member 6 is attached to the lower surface of the substrate 1 by an adhesive, for example. The sealing member 6 prevents the accommodated elements (particularly, the scanning electrodes 5 and the organic layers 4) from being adversely affected by outside moisture, for example.

The light exposure of the photosensitive recording medium F is performed in the manner shown in FIG. 2. Specifically, the recording medium F, pressed onto the upper surface of the substrate 1 by the platen roller P, is moved in the secondary scanning direction Y relative to the substrate 1 at a prescribed constant speed. Meanwhile, the light-emitting portions 421R, 421G and 421G, as required, are sequentially activated for light emission. For a prescribed period of time (referred to as “one pitch feed time” below), the recording medium F is forwarded in the direction Y by a distance=the recording medium feeding speed×the one pitch feed time (this distance is referred to as “one pitch distance” below). The light-emitting portions 421R, when selected, are activated only once for every one pitch feed time. The voltage application time (precisely, scanning voltage application time) for the light-emitting portions 421R is predetermined within the one pitch feed time, as described in detail below. Likewise, the light-emitting portions 421G and the light-emitting portions 421B, when selected, are activated only once for every one pitch feed time, and the voltage application times (scanning voltage application times) for the portions 421G and 421B are predetermined within the one pitch feed time. The cycle of the voltage application time for the portions 421R is in synchronism with the cycle of the one pitch feed time, and so are the cycles of the voltage application times for the portions 421G and the portions 421B. Thus, the photosensitive recording medium F can be illuminated sequentially for every one pitch feed time by the red light-emitting portions 421R, and then the green light-emitting portions 421G, and then the blue light-emitting portions 421B. As a result, a required color image (latent image) is formed in a required region on the recording medium F.

FIG. 1B shows waveforms of scanning voltage applied during the one pitch feed time TP with respect to the red, green and blue light-emitting portions 421R, 421G, 421B. As seen from the figure, the one pitch feed time TP consists of two periods of time: a luminescent period (TR+TG+TB) and a non-luminescent period (TN, which is equal to TP−(TR+TG+TB)).

For the luminescent period, it is possible to select at least one of the light-emitting portions 421R, 421G, 421B and activate (energize) the selected one(s) for light emission, or select none of them, so that no light emission happens to occur. In the example shown in FIG. 1B, all the three kinds of light-emitting portions 421R, 421G and 421B can be selected for light emission for the luminescent period (=TP−TN). However, this illustrates only one option of the driving manner, to which the present invention is not limited. In light of these, the luminescent period may be referred to as a “light emission possible period” in which any one of the light-emitting portions 421R, 421G and 421B can be selected for light emission, as required. Again, this includes the case where no light-emitting portions 421R, 421G and 421B happen to be selected due to a particular print instruction to that extent.

The non-luminescent period TN, on the other hand, the above-mentioned selection of the light-emitting portions is not allowed. Thus, no matter what print instructions are issued, the light-emitting portions 421R, 421G and 421B are never activated for light emission.

In the embodiment shown in FIG. 1B, the starting point of the voltage application time TR for the red light-emitting portions 421R is timed to coincide with the starting point of the one pitch feed time TP. Then, the voltage application time TR comes to an end, while the voltage application time TG for the green light-emitting portions 421G starts immediately so as not to allow any time gap to exist between the end of the time TR and the start of the time TG. Likewise, as the voltage application time TG comes to an end, the voltage application time TB starts immediately with no gap allowed between the time TG and the time TB. According to the present invention, the ratio of the voltage application time TR, TG, TB to the one pitch feed time TP is in a range of 1/60- 1/20 for example. As the third voltage application time TB ends, the non-luminescent time TN follows immediately. As noted above, in the non-luminescent time TN, none of the light-emitting portions 421R, 421G, 421B is supposed to be activated for light emission.

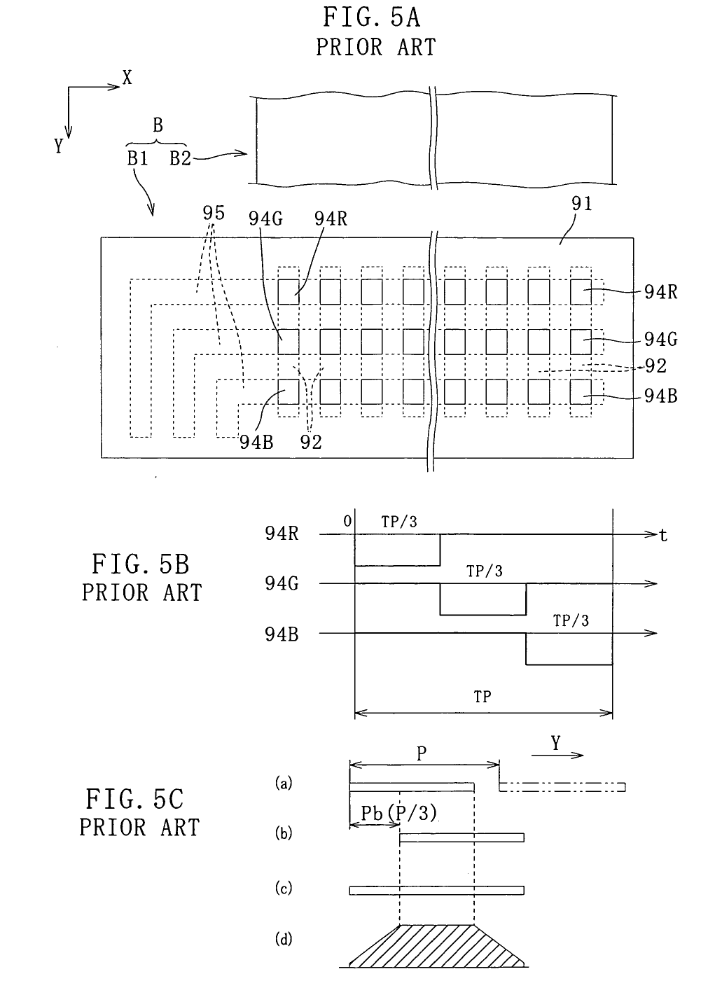

FIG. 3 illustrates an instance where the ratio of the voltage application time to the one pitch feed time is 1/20. In this case, one light-emitting portion (horizontally elongated rectangular) is moved in the secondary scanning direction Y by a distance of Pa=P/20 (see (b)) relative to the recording medium F, where P is one pitch (see (a); the solid lines indicate the initial position of the light-emitting portion, while the two-dot chain lines indicate the position of the same portion after the one pitch feed time has lapsed). As moved by P/20 in the direction Y, the light-emitting portion forms a rectangular latent image (see (c)), which is slightly elongated in the direction Y, but is much smaller than the conventional one shown in FIG. 5C(c) where the voltage application time is ⅓ of the one pitch feed time TP. Due to the small displacement of the light-emitting portion, the light exposure for making one dot on the recording medium F can be substantially uniform over the entire range of the dot (see (d) in FIG. 3). Accordingly, the print quality of the resultant dot is improved. Further, since the elongation of the print dot is prevented, it is possible to prevent any two print dots adjacent in the secondary scanning direction Y from overlapping each other. Consequently, it is possible to reduce the occurrence of undesired print strips caused by the overlapping of the adjacent print dots.

As noted above, the ratio of the voltage application time TR, TG, TB to the one pitch feed time TP is preferably in the range of 1/60 to 1/20. The present invention, however, is not limited to this, and the ratio may be adjusted depending on conditions such as a print dot pitch or the voltage applied to the light-emitting portions, for example.

With the above arrangement, adjustments of the voltage application time TR, TG, TB are readily performed by controlling the timing of the application of scanning voltage to the light-emitting portions 421R, 421G, 421B. Further, in the above embodiment, the non-luminescent time TN is significantly longer than each of the voltage application times TR, TG, TB. This means that the one pitch feed time TP has sufficient room to permit a required adjustment of the voltage application time TR, TG or TB. As an example, suppose that only the first voltage application time TR (originally equal to e.g. TP/20) among the three application times needs to be doubled (namely, increased to TP/10) without changing the predetermined length of the one pitch feed time TP. According to the present invention, this is achieved simply by decreasing the non-luminescent time TN by TP/20 (=TP/10−TP/20). In the conventional case (see FIG. 5B), the three voltage application times are fitted into the one pitch feed time TP closely, i.e., with no non-luminescent time provided. Thus, the above-mentioned adjustment of the first voltage application time TR cannot be achieved without altering the one pitch feed time TP or the second or third voltage application time TG, TB.

As is known, when luminescent layers of organic EL emit light of different colors, they have different electrical properties such as light-emitting efficiencies. Consequently, the three kinds of light-emitting portions 421R, 421G, 421B in the above-described embodiment have different light-emitting efficiencies. Specifically, the portions 421R has the lowest efficiency, the portions 421B the second lowest efficiency, and the portions 421G the third lowest, i.e., the highest efficiency. Thus, though the portions 421R, 421B, 421G are supplied with the same current, their brightness is different (specifically, the portion 421G is the brightest, the portion 421B the second brightest, and the portion 421R the darkest.). In the embodiment (see FIG. 1B), to equalize the amount of light exposure (more precisely, the amount of maximum light exposure) by the three portions 421R, 421B and 421G, the voltage application time TR is the longest, the voltage application time TB the second longest, and the voltage application time TG the shortest, so that the product of brightness and exposure time (voltage application time) is the same for the three kinds of light-emitting portions. Advantageously, such equalized light exposure contributes to the improvement of the print quality.

In the organic EL printer A of the present invention, the voltage application time TR, TG, TB of each light-emitting portion 421R, 421G, 421B is variable within a predetermined maximum range in accordance with supplied print data. With this arrangement, the amount of light exposure of each color (R, G, B) can be increased or decreased within the preset range, thereby attaining a multi-tone expression in the resultant print. In this case, the modified voltage application time may still be disposed continuously with the adjacent voltage application time(s), as shown in FIG. 1B.

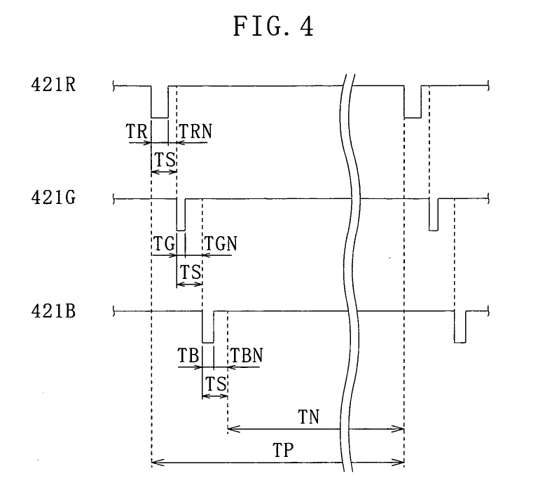

Differing from the above embodiment, the voltage application times TR, TG, TB may be spaced away from each other, as shown in FIG. 4. In such a case, a maximum time window TS may be preset within the one pitch feed time TP for each of the three voltage application times TR, TG, TB (thus, three time windows TS are provided). As shown in the figure, the three time windows TS are arranged continuously with each other, and their lengths are the same (TP/20, for example). Within each time window TS, the relevant voltage application time TR, TG or TB can be adjusted in length. In the illustrated example, the ratio of the voltage application time to the one pitch feed time is 1/30, 1/60 and 1/45 for the times TR, TG and TB, respectively. In the first time window TS (the top one in FIG. 4), a non-luminescent time TRN follows the voltage application time TR immediately, i.e., without allowing no gap between the two times. Likewise, in the second (middle) and third (bottom) time windows TS, non-luminescent times TGN and TBN immediately follow the voltage application times TG and TB, respectively. Accordingly, in this embodiment, the three voltage application times TR, TG, TB are disposed intermittently, which differs from the case of the first embodiment where the three voltage application times are disposed continuously (FIG. 1B).

In the above-described embodiment again, each voltage application time TR, TG, TB is no greater than TP/20, for example. Thus, in comparison with the conventional case (where the voltage application time is TP/3, which is significantly longer than that of the present invention), it is possible to reduce the unfavorable elongation of print dots formed on the photosensitive recoding medium F. Accordingly, it is possible to prevent unevenness of print density from appearing in the developed images, whereby the print quality improves.

The present invention being thus described, it is obvious that the same may be varied in many ways. In the above-described embodiments, three kinds of light-emitting portions are used for providing red, green and blue light. Alternatively, only one kind of light-emitting portions that emit while light may be used together with color filters through which the white light is changed into red, green and blue light. Such variations are not to be regarded as a departure from the spirit and scope of the present invention, and all such modifications as would be obvious to those skilled in the art are intended to be included within the scope of the following claims.

1. An organic EL printer comprising:
an organic EL panel for illuminating a photosensitive recording medium, the panel including a plurality of light-emitting portions disposed in form of a matrix extending both in a primary scanning direction and in a secondary scanning direction, the plurality of light-emitting portions including a red light-emitting portion, a green light-emitting portion and a blue light-emitting portion;
a moving unit for moving the recording medium and the panel relative to each other in the secondary scanning direction by one pitch distance in one pitch feed time; and
a drive controller for setting voltage application times within the one pitch feed time with respect to the red light-emitting portion, the green light-emitting portion and the blue light-emitting portion, the drive controller causing the red light-emitting portion, the green light-emitting portion and the blue light-emitting portion to emit light in accordance with the voltage application times;
wherein the one pitch feed time includes a non-luminescent time in addition to the voltage application times.

2. The printer according to claim 1, wherein each of the red light-emitting portion, the green light-emitting portion and the blue light-emitting portion has a light-emitting efficiency, the light-emitting efficiencies of these portions being different from each other.

3. The printer according to claim 1, wherein the voltage application times of the red light-emitting portion, the green light-emitting portion and the blue light-emitting portion have lengths different from each other.

4. The printer according to claim 1, wherein the voltage application time of the red light-emitting portion is longer than the voltage application time of the blue light-emitting portion, and wherein the voltage application time of the green light-emitting portion is shorter than the voltage application time of the blue light-emitting portion.

5. The printer according to claim 1, wherein the voltage application times of the red light-emitting portion, the green light-emitting portion and the blue light-emitting portion are set continuously with each other.
